(19) United States
(12) Patent Application Publication
(10) Pub. No.: US 2020/0126108 A1
(43) Pub. Date: Apr. 23, 2020

(54) EARN WITH ACTIVITY MONITORED BY WEARABLE SMART DEVICES

(71) Applicants: Muhammad Bassam Adil Khan, San Mateo, CA (US); RiteshKumar Joshi, Foster City, CA (US)

(72) Inventors: Muhammad Bassam Adil Khan, San Mateo, CA (US); RiteshKumar Joshi, Foster City, CA (US)

(21) Appl. No.: 16/164,381

(22) Filed: Oct. 18, 2018

(51) Int. Cl. G06Q 30/02; H04L 29/08

(52) U.S. Cl. CPC G06Q 30/0232; H04L 67/22; G06Q 30/0236; G06Q 30/0224

(57) ABSTRACT

The described system and method may provide rewards to users for undertaking activities and may provide the ability to use the rewards to buy goods or services.

### BACKGROUND

Merchants are interested in having more consumers buy items from them. Consumers are interested in receiving rewards in response to buying goods or undertaking activities. Rewards may be obtained a in a variety of ways but the usual way to earn rewards is to spend money.

### SUMMARY

The described system and method may provide rewards to users for undertaking activities and may provide the ability to use the rewards to buy goods or services. The rate that awards are granted may vary by user and may be adjusted by a learning algorithm. Further, the award level threshold for goods or services may vary by user and may be adjusted by a learning algorithm.

### BRIEF SUMMARY OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows an illustration of an exemplary system for using activity rewards to buy goods or services;

FIG. 2A shows a first view of an exemplary payment device for use with the system of FIG. 1;

FIG. 2B shows a second view of an exemplary payment device for use with the system of FIG. 1;

FIG. 3 shows an exemplary machine learning architecture;

FIG. 4 shows an exemplary artificial intelligence architecture;

FIG. 5 is a flowchart of a method for rewarding activity and using the rewards to buy goods or services within the system of FIG. 1;

FIG. 6 shows an exemplary computing device that may be physically configured to execute the methods and include the various components described herein; and

FIG. 7 shows an illustration of another embodiment of the system for using an activity tracking system to grant rewards and pay for goods or services.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, components, or devices. Accordingly, the present invention may take the form of an entirely hardware embodiment, an entirely software embodiment, or an embodiment combining software and hardware aspects. The hardware may be local, may be remote or may be a combination of local and remote. The following detailed description is, therefore, not to be taken in a limiting sense.

At a high level, the system and method may use enrollment in an activity tracking application to enroll, with the user's permission, in a credit awarding application whereby credits may be earned by performing an activity tracked by the activity tracker. The rate of earning rewards and the level of rewards needed to earn a reward

From a technical standpoint, enrolling users in systems, even systems that provide rewards, is a technical challenge as users do not desire to re-enter the same information repeatedly. In addition, people often do not trust systems with their personal information. By allowing enrollment data 119 previously entered to flow from one application to another, the technical solution reduces repeated entry of personal information and reduces typing errors. Even communicating enrollment data 119 may be a technical challenge in view of the security issues and possible errors and the use of protocols and APIs may address these technical problems.

Similarly, it is a technical problem to determine the rate to reward specific users and the level of points needed to complete a transaction for specific individuals. Some users may be more desirable than others to certain merchants. Determining the rates to reward users to affect their behavior is a technical problem. Similarly, determining the rates to allow users to redeem points to affect their behaviors is a technical problem. Artificial intelligence may be used to address this technical problem with a technical solution based on studying large amounts of similar people.

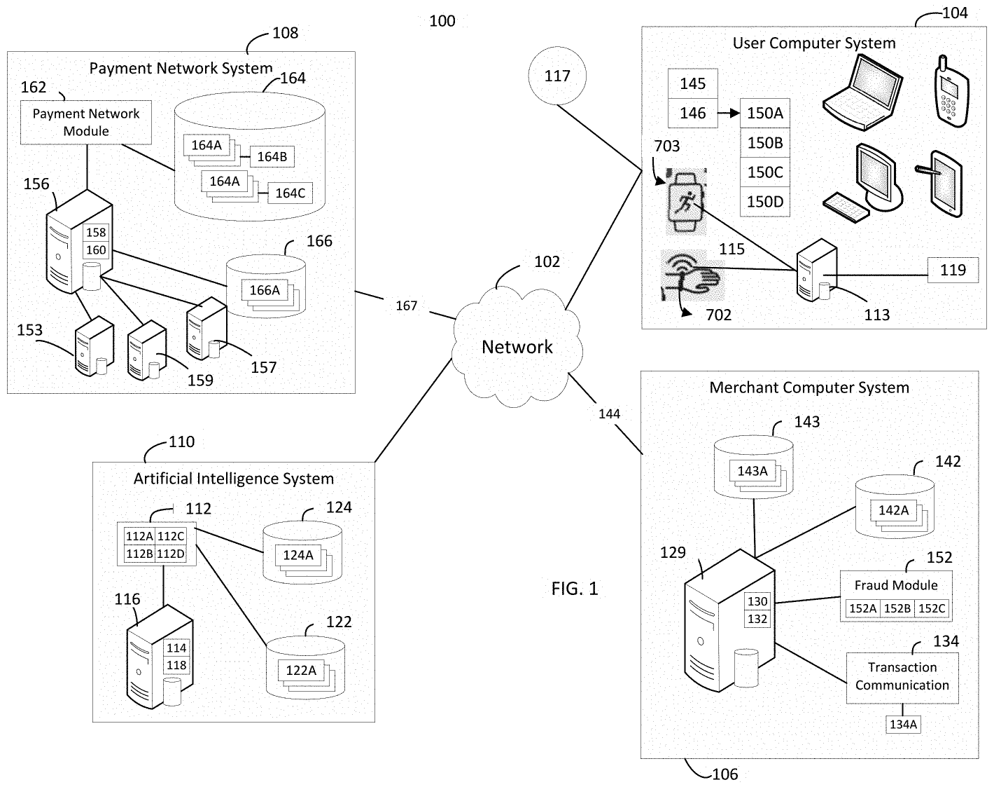

FIG. 1 generally illustrates one embodiment of a payment system 100 for determining providing rewards for actions and allowing the rewards to be used to be deemed for good or services. The system 100 may include a computer network 102 that links one or more systems and computer components. In some embodiments, the system 100 includes a user computer system 104, a merchant computer system 106, a payment network system 108, and a activity analysis system which may embody artificial intelligence 110.

The network 102 may be described variously as a communication link, computer network, internet connection, etc. The system 100 may include various software or computer-executable instructions or components stored on tangible memories and specialized hardware components or modules that employ the software and instructions to identify related transaction nodes for a plurality of transactions by monitoring transaction communications between users and merchants.

The various modules may be implemented as computer-readable storage memories containing computer-readable instructions (i.e., software) for execution by one or more processors of the system 100 within a specialized or unique computing device. The modules may perform the various tasks, methods, blocks, sub-modules, etc., as described herein. The system 100 may also include both hardware and software applications, as well as various data communications channels for communicating data between the various specialized and unique hardware and software components.

Networks are commonly thought to comprise the interconnection and interoperation of hardware, data, and other entities. A computer network, or data network, is a digital telecommunications network which allows nodes to share resources. In computer networks, computing devices exchange data with each other using connections, i.e., data links, between nodes. Hardware networks, for example, may include clients, servers, and intermediary nodes in a graph topology. In a similar fashion, data networks may include data nodes in a graph topology where each node includes related or linked information, software methods, and other data.

It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications or data network. A computer, other device, set of related data, program, or combination thereof that facilitates, processes information and requests, and/or furthers the passage of information from a source user to a destination user is commonly referred to as a “node.”

Networks generally facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

A user computer system 104 may include a processor 145 and memory 146. The user computing system 104 may include a server, a mobile computing device, a smartphone, a tablet computer, a Wi-Fi-enabled device, wearable computing device or other personal computing device capable of wireless or wired communication, a thin client, or other known type of computing device. As will be discussed further, the user computer system may be used to track activity and the activity may vary.

The memory 146 may include various modules including instructions that, when executed by the processor 145 control the functions of the user computer system generally and integrate the user computer system 104 into the system 100 in particular. For example, some modules may include an operating system 150A, a browser module 150B, a communication module 150C, and an electronic wallet module 150D. In some embodiments, the electronic wallet module 150D and its functions described herein may be incorporated as one or more modules of the user computer system 104. In other embodiments, the electronic wallet module 150D and its functions described herein may be incorporated as one or more sub-modules of the payment network system 108. In some embodiments, a responsible party 117 is in communication with the user computer system 104.

In some embodiments, a module of the user computer system 104 may pass user payment data to other components of the system 100 to facilitate determining a real-time transaction analysis determination. For example, one or more of the operating system 150A, a browser module 150B, a communication module 150C, and an electronic wallet module 150D may pass data to a merchant computer system 106 and/or to the payment network system 108 to facilitate a payment transaction for a good or service. Data passed from the user computer system 104 to other components of the system may include a customer name, a customer ID (e.g., a Personal Account Number or “PAN”), address, current location, and other data.

The data may be passed according to a preset protocol. In a protocol, the arrangement of the data may be set in advance and both parties may know certain data of a certain length goes in a certain place in a communication. In some embodiments, encryption of tokens may be used to ensure the data is kept secure. The data also may be passed using an application programming interface (API).

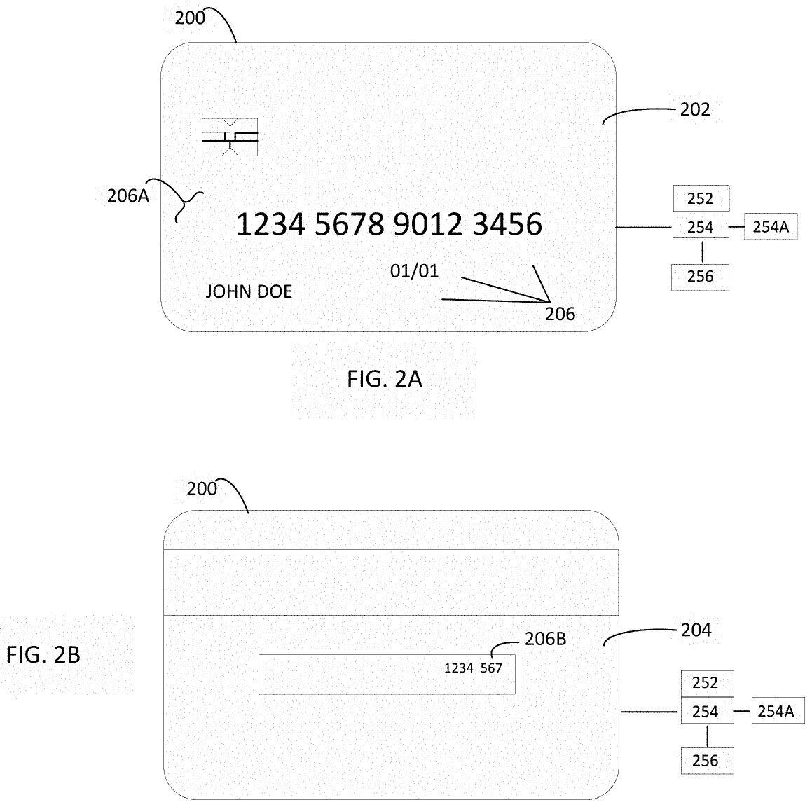

The merchant computer system 106 may include a computing device such as a merchant server 129 including a processor 130 and memory 132 including components to facilitate transactions with the user computer system 104 and/or a payment device 200 (FIG. 2) via other entities of the system 100. In some embodiments, the memory 132 may include a transaction communication module 134. The transaction communication module 134 may include instructions to send merchant messages 134A to other entities (e.g., 104, 108, 110) of the system 100 to indicate a transaction has been initiated with the user computer system 104 and/or payment device 200 including payment device data and other data as herein described. The merchant computer system 106 may include a merchant transaction repository 142 and instructions to store payment and other merchant transaction data 142A within the transaction repository 142. The merchant transaction data 142A may only correspond to transactions for products with the particular merchant or group of merchants having a merchant profile (e.g., 164B, 164C) at the payment network system 108.

The merchant computer system 106 may also include a product repository 143 and instructions to store product data 143A within the product repository 143. For each product offered by the merchant computer system 106, the product data 143A may include a product name, a product UPC code, an item description, an item category, an item price, a number of units sold at a given price, a merchant ID, a merchant location, a customer location, a calendar week, a date, a historical price of the product, a merchant phone number(s) and other information related to the product. In some embodiments, the merchant computer system 106 may send merchant payment data corresponding to a payment device 200 (FIG. 2) to the payment network system 108 or other entities of the system 100, or receive user payment data from the user computer system 104 in an electronic wallet-based or other computer-based transaction between the user computer system 104 and the merchant computer system 106.

The merchant computer system 106 may also include a fraud module 152 having instructions to facilitate determining fraudulent transactions offered by the merchant computer system 106 to the user computer system 104. The fraud API 152A may include instructions to access one or more backend components (e.g., the payment network system 108, the artificial intelligence engine 110, etc.) and/or the local fraud module 152 to configure a fraud graphical interface 152B to dynamically present and apply the transaction analysis data 144 to products or services 143A offered by the merchant computer system 106 to the user computer system 104. A merchant historical fraud determination module 152C may include instructions to mine merchant transaction data 143A and determine a list of past fraudulent merchants to obtain historical fraud information on the merchant.

The payment network system 108 may include a payment server 156 including a processor 158 and memory 160. The memory 160 may include a payment network module 162 including instructions to facilitate payment between parties (e.g., one or more users, merchants, etc.) using the payment system 100. The module 162 may be communicably connected to an account holder data repository 164 including payment network account data 164A. A reward server 153 may in communication with the payment server 156.

The payment network account data 164A may include any data to facilitate payment and other funds transfers between system entities (e.g., 104, 106). For example, the payment network account data 164A may include account identification data, account history data, payment device data, etc. The module 162 may also be communicably connected to a payment network system transaction repository 166 including payment network system global transaction data 166A.

The global transaction data 166A may include any data corresponding to a transaction employing the system 100 and a payment device 200 (FIG. 2). For example, the global transaction data 166A may include, for each transaction across a plurality of merchants, data related to a payment or other transaction using a PAN, account identification data, a product or service name, a product or service UPC code, an item or service description, an item or service category, an item or service price, a number of units sold at a given price, a merchant ID, a merchant location, a merchant phone number(s), a customer location, a calendar week, and a date, corresponding to the product data 143A for the product that was the subject of the transaction or a merchant phone number. The module 162 may also include instructions to send payment messages 167 to other entities and components of the system 100 in order to complete transactions between users of the user computer system 104 and merchants of the merchant computer system 106 who are both account holders within the payment network system 108.

The artificial intelligence engine 110 may include one or more instruction modules including a transaction analysis module 112 that, generally, may include instructions to cause a processor 114 of a transaction analysis server 116 to functionally communicate with a plurality of other computer-executable steps or sub-modules, e.g., sub-modules 112A, 112B, 112C, 112D and components of the system 100 via the network 102. These modules 112A, 112B, 112C, 112D may include instructions that, upon loading into the server memory 118 and execution by one or more computer processors 114, dynamically determine transaction analysis data for a product 143A or a merchant 106 using various stores of data 122A, 124A in one more databases 122, 124. As an example, sub-module 112A may be dedicated to dynamically determine transaction analysis data based on transaction data associated with a merchant 106.

With brief reference to FIGS. 2A and 2B, an exemplary payment device 200 may take on a variety of shapes and forms. In some embodiments, the payment device 200 is a traditional card such as a debit card or credit card. In other embodiments, the payment device 200 may be a fob on a key chain, an NFC wearable like an activity tracker, or other device. In other embodiments, the payment device 200 may be an electronic wallet where one account from a plurality of accounts previously stored in the wallet is selected and communicated to the system 100 to execute the transaction. As long as the payment device 200 is able to communicate securely with the system 100 and its components, the form of the payment device 200 may not be especially critical and may be a design choice. For example, many legacy payment devices may have to be read by a magnetic stripe reader and thus, the payment device 200 may have to be sized to fit through a magnetic card reader. In other examples, the payment device 200 may communicate through near field communication and the form of the payment device 200 may be virtually any form. Of course, other forms may be possible based on the use of the card, the type of reader being used, etc.

Physically, the payment device 200 may be a card and the card may have a plurality of layers to contain the various elements that make up the payment device 200. In one embodiment, the payment device 200 may have a substantially flat front surface 202 and a substantially flat back surface 204 opposite the front surface 202. Logically, in some embodiments, the surfaces 202, 204 may have some embossments 206 or other forms of legible writing including a personal account number (PAN) 206A and the card verification number (CVN) 206B. In some embodiments, the payment device 200 may include data corresponding to the primary account holder, such as payment network account data 164A for the account holder. A memory 254 generally and a module 254A in particular may be encrypted such that all data related to payment is secure from unwanted third parties. A communication interface 256 may include instructions to facilitate sending payment data 143B, 143A such as a payment payload, a payment token, or other data to identify payment information to one or more components of the system 100 via the network 102.

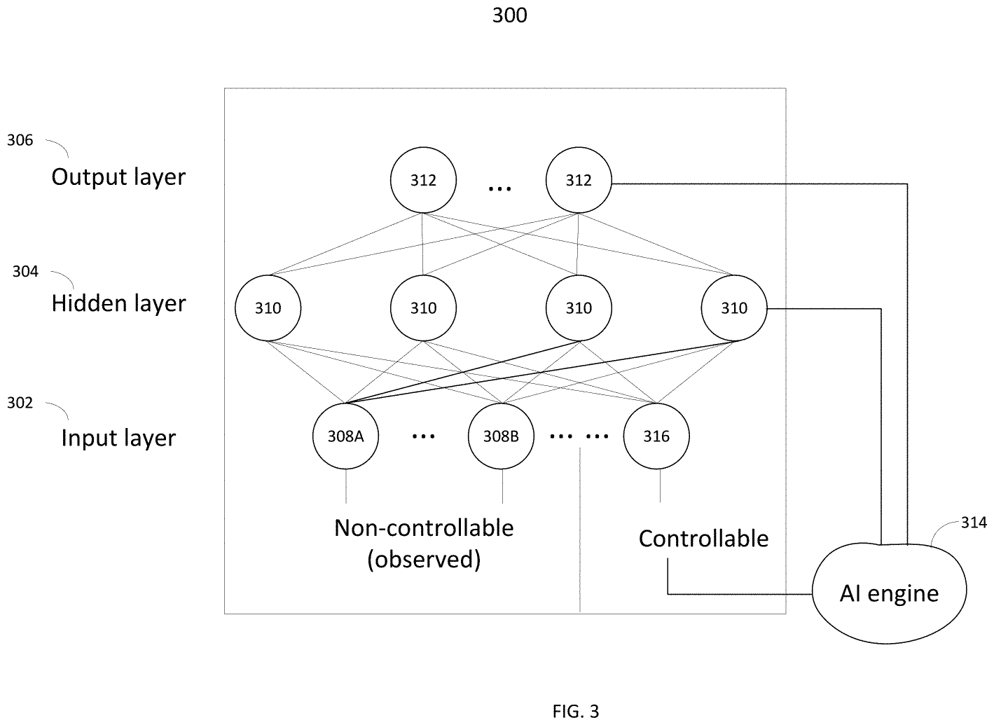

With reference to FIG. 3, a machine learning (ML) architecture 300 may be used with the transaction analysis module 112 of system 100 in accordance with the current disclosure. In some embodiments, an Al module 112D of the artificial intelligence system 110 may include instructions for execution on the processor 114 that implement the ML architecture 300. The ML architecture 300 may include an input layer 302, a hidden layer 304, and an output layer 306. The input layer 302 may include inputs 308A, 308B, etc., coupled to the transaction analysis module 112 and represent those inputs that are observed from actual product, customer, and merchant data in the transaction data 142A, 166A. The hidden layer 304 may include weighted nodes 310 that have been trained for the transactions being observed. Each node 310 of the hidden layer 304 may receive the sum of all inputs 308A, 308B, etc., multiplied by a corresponding weight. The output layer 306 may present various outcomes 312 based on the input values 308A, 308B, etc., and the weighting of the hidden layer 304. Just as a machine learning system for a self-driving car may be trained to determine hazard avoidance actions based on received visual input, the machine learning architecture 300 may be trained to analyze a likely outcome for a given set of inputs based on thousands or even millions of observations of previous customer/merchant transactions. For example, the architecture 300 may be trained to determine transaction analysis data 144 to be associated with the product data 143A.

During training of the machine learning architecture 300, a dataset of inputs may be applied and the weights of the hidden layer 310 may be adjusted for the known outcome (e.g., a transaction analysis baseline) associated with that dataset. As more datasets are applied, the weighting accuracy may improve so that the outcome prediction is constantly refined to a more accurate result. In this case, the merchant transaction repository 142 and/or the payment network system repository 166 respectively including transaction data 142A and 166A may provide datasets for initial training and ongoing refining of the machine learning architecture 300.

Additional training of the machine learning architecture 300 may include the an artificial intelligence engine (AI engine) 314 providing additional values to one or more controllable inputs 316 so that outcomes may be observed for particular changes to the transaction analysis data 142A and 166A. The values selected may represent different data types such as community responses, merchant ratings and other alternative data presented at various points in the transaction process with the product data and may be generated at random or by a pseudo-random process. By adding controlled variables to the transaction process, over time, the impact may be measured and fed back into the machine learning architecture 300 weighting to allow capture of an impact on a proposed change to the process in order to optimize the determination of the transaction analysis data 144. Over time, the impact of various different data at different points in the transaction cycle may be used to predict an outcome for a given set of observed values at the inputs layer 302.

After training of the machine learning architecture 300 is completed, data from the hidden layer may be fed to the artificial intelligence engine 314 to generate values for controllable input(s) 316 to optimize the transaction analysis data 144. Similarly, data from the output layer may be fed back into the artificial intelligence engine 314 so that the artificial intelligence engine 314 may, in some embodiments, iterate with different data to determine via the trained machine learning architecture 300, whether the transaction analysis data 144 is accurate, and other determinations.

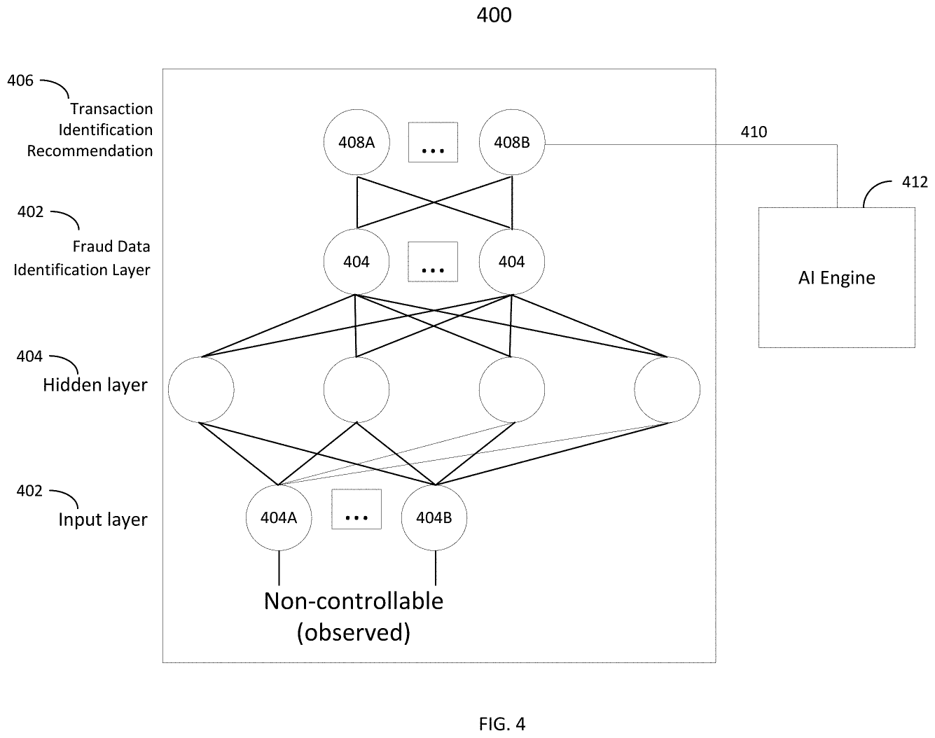

With reference to FIG. 4, in other embodiments, the machine learning architecture 300 and artificial intelligence engine 314 may include a second instance of a machine learning architecture 400 and/or an additional node layer may be used. In some embodiments, a transaction analysis data identification layer 402 may determine an optimum transaction analysis determination 404 from observed inputs 404A, 404B. A transaction analysis layer 406 with outputs 408A, 408B, etc., may be used to generate transaction analysis recommendations 410 to an artificial intelligence engine 412, which in turn, may modify one or more of transaction data generally and the transaction analysis data in particular when communicating this data via an appropriate SDK.

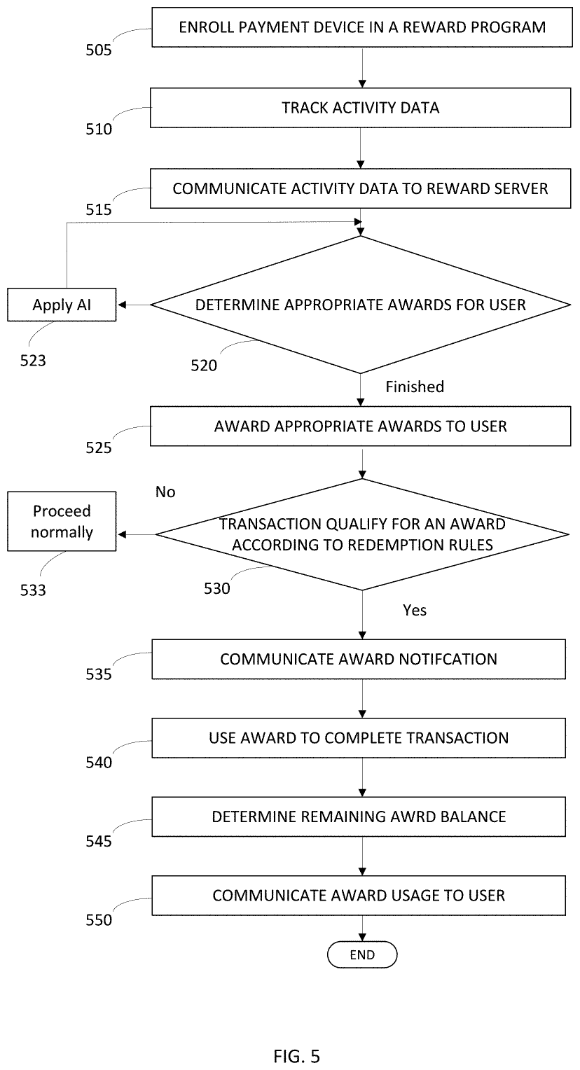

FIG. 5 may illustrate a method to earn rewards for using a service. The method and system may have a high level goal of rewarding or directing behavior. The service may have many embodiments such as an activity tracking service, an electricity delivery service, an internet delivery service, a water delivery service or even using an appliance that is internet connected such as a smart refrigerator, or smart washing machine.

A technical problem is how to enroll people in a reward program to reward or direct behavior. Further, another technical problem is how to determine rewards for different users. Yet another technical problem is how to communicate data from one application to another application in a manner and format that makes the process efficient and reliable.

The method and system provide technical details to address these technical problems. By creating APIs and protocols to exchange data from one app to another app with sufficient permissions, reliable and predictable communication of data is possible. Further, the burden on users is reduced as data will not have to be repeatedly re-entered as it may be communicated electronically. Finally users may be able to earn rewards for things they do on an everyday basis.

Referring again to FIG. 5, at block 505 at a reward server 153 as part of the payment network system 108, a payment device 200 may be enrolled for a user in a reward program. The enrollment may occur in a variety of ways. In some embodiments, the user may be enrolled in a first system and, with sufficient permission, may share the enrollment information with the reward server 153.

The enrollment information may be communicated according to a known protocol. The enrollment information may be stored in a variety of formats and often may be encrypted. However, the system and method may be able to communicate the needed information and, with sufficient permission from the user, communicate the enrollment information in a predefined format.

In some embodiments, the activity program may have an application programming interface (API) that may respond with the enrollment information for a user when sufficient permissions are present. The API may be supplied by the reward server 153 for incorporation into the activity tracking program or the API may be publically available to ease incorporation into many activity tracking programs. The reward server 153 may request the enrollment information in a known format and the API may respond with the enrollment information in a known format thereby eliminating errors and improving efficiency. Again, the enrollment information may be communicated in the form of a token and the reward server 153 may be able to translate the token into meaningful enrollment information if sufficient permissions are present. More specifically, in some embodiments, a token and a token server may be used to communicate the enrollment information. In such an embodiment, the actual enrollment information may not be communicated but a token that represents the information may be communicated. If the receiving application has the proper permissions, the token may be converted into the desired enrollment information.

In some embodiments, permission may be obtained from the user in the first application to share the data with the reward server 153 in the payment network system 108. The user may select a box of may select an option to share the enrollment information. In other embodiments, the reward server 153 may have a user interface and the reward server 153 may negotiate with the first system to retrieve the enrollment information. In some embodiments, the reward server 153 may communicate instructions to the user to manually enable the first application to share the enrollment information with the reward server 153.

The payment device 200 may be a representation of a store of value or credit. A common example may be a credit card or a debit card. The payment device 200 may also include a checking account number or a frequent flyer account number or other representation of value or credit. It may be embodied in a physical card or it may be electronic representations of the personal account number (PAN) as illustrated in FIGS. 2a and 2b.

The reward program may operate on the reward server 153 and may be a program that provides rewards or offers in response to user action or inaction. In some instances, the reward program may desire to reward a user for exercising. The reward program make take in workout data and may provide rewards based on the data. The reward program may have a user interface to allow it to be modified by users and by merchants and other program participants.

The reward server 153 may be physically configured in a way to improve communication and respond quickly when queried. It may have a larger buffer for communications and a processor that is adapted more toward algorithmic computation and less toward visual display.

In some embodiments, the first application may be an activity collection server 104. The activity may be physical activity such as from a portable device that is kept with a user and tracks the physical activity of the user. In other embodiments, the activity may be use of a service such as the amount of electricity that is used or the amount of water that is used. In other embodiments, the activity may be from an Internet of Things (IoT) enable device such as a refrigerator or toaster oven. By offering rewards for obtaining a level of service, the behavior of the user may be changed. For example, by rewarding physical activity, people may be more active and more healthy. Similarly, by rewarding users to open a refrigerator less, less energy may be used and the lower electricity usage may have societal benefits.

At block 510, at an activity collection server, activity data 115 may be tracked from the user. The activity collection server 104 may be a single device or may be a plurality of devices such as a series of computers operating in a cloud type computing arrangement. The activity collection server 104 may take a variety of forms depending on the activity tracking device 702.

In embodiments where the activity tracking device 702 is a wearable, the wearable may only communicate with the activity server 113 periodically, such as when it is charging or when it is in communication with WiFi or a Bluetooth receiver, for example. In other embodiments, the activity tracking device 702 may be able to communicate in real time and the activity server 113 may continually receive data from the device.

In other embodiments, the activity tracker may be an IoT appliance. The IoT appliance may collect data on activity of the device and may report the data to the activity service. In some embodiments, the reporting of data may be in real time or may be accumulated and reported periodically.

As mentioned previously, the activity data 115 may be in many forms and may be collected such that desired behavior may be encouraged. Examples of the activity data 115 may include a human activity monitor, an appliance, a smart electric meter, or even a car that is IoT enabled. As mentioned earlier, the activity collection server 104 may have permission to collect data from the activity sensor.

In some embodiments, application programming interfaces (APIs) are used to obtain the activity data 115. For example, the activity collection server 104 may request data from the activity tracker and in response, the activity tracker may respond with the activity data 115. The activity data 115 may be provided according to a protocol. As mentioned previously, tokens and a token server may be used for more security.

At block 515, activity data 115 may be communicated for the user to a reward server 153. Logically, for the user to gain any rewards, the activity data 115 may need to be communicated to the reward server 153. As mentioned previously, the activity data 115 may be communicated according to a protocol. In addition, in some embodiments, the activity data 115 may be communicated according to an API.

At block 520 at the reward server 153 may determine appropriate rewards to be granted to the user based on the activity data 115 for the user. The rewards may be stored and saved to be used at a point in the future. The appropriate reward may depend on a variety of factors and may take on a variety of forms.

In a simple embodiment, all users may earn rewards at the same pace. In other embodiments, users with a transaction level over a threshold my earn rewards at a faster rate. In other embodiments, some users may be desired by some merchants and rewards may be offered at a faster rate. The ability to select users may occur in a variety of ways.

In some embodiments, a user interface may be provided to merchants to request users with certain attributes. For example, the merchant may desire users near a brick and mortar store. In another example, the merchant may desire users that are heavy online shoppers. In yet another example, the merchant may desire users that spend over a threshold each month. The selected user may be compensated with reward points at a first rate and other users may be rewarded at a different rate.

In yet an additional embodiment, artificial intelligence as illustrated in FIGS. 3 and 4 may be used at block 523 to assist in further identifying users that may be more likely to be attractive to the merchant based on the attributes selected by the merchant. For example, the if merchant is selling luxury goods, it would be useful to know that users are likely to purchase luxury goods. By analyzing large amounts of purchase data, the system and method may become proficient at predict users that are likely to buy luxury goods and when they will buy luxury goods.

As an example, a large amount of transaction data may be available to be analyzed. The high level idea may be that predictions of behavior may be learned by analyzing large amounts of data from the past. The data may be broken into groups, for example, four groups. Three groups may be analyzed and the fourth group may be used to test any determinations that may be made from analyzing the first, second and third groups. Then, the groups may rotate with the first group being used as a test group and groups second, three and four groups may be the analysis groups. The groups may continue to rotate until all the groups have been used as a test group. By analyzing the large amount of data, knowledge may be learned from the data and that knowledge may be used to make better decisions in the future.

Specific to this system and method, the transactions may be analyzed to try to meet the needs of the merchants. For example, if a merchant desires to sell more goods to affluent users, the transaction data may be analyzed to determine what may be done to increase sales to affluent users by analyzing the purchase habits of affluent users and determining if any patterns or triggers may be determined.

As a result, the awards may be tailored to attract a desired audience. By increasing the award, behavior may be modified in a desired way or level. Similarly if a behavior is not desired, rewards may be lowered to reduce the incentive to do something.

At block 525, the appropriate awards for the user may be awarded to an award account for the user. In some embodiments, the awards may appear in real time and in other embodiments, there may be a delay in the points appearing in the award account of the user. The user may receive a notification that the points have been added to the account. In some embodiments, the notification may be communicated to the activity tracking device 702. In other embodiments, users may select how they would like to receive the award through a user interface.

At block 530 at a transaction processing server the method and system may determine if a transaction for the user qualifies for an award according to redemption rules. Logically, there may be rules to determine which purchases qualify for a reward. The rules may be determined by the merchant or by the manufacturer of goods or the provider of services. The rules may be communicated to the transaction processing server and transaction processing server may store the rules and compare transactions against the rules. The rules may be communicated in a variety of ways. In some embodiments, the rules may be added using a user interface. In other embodiments, a protocol may be used to communicate the rules to the transaction processing server. In yet another embodiment, a flat file may be created and communicated to the transaction processing system. Again, in some embodiments, the flat file may be created using a user interface through an application where the goods or services are added and the user interface created the flat file or file according to the protocol which may then be communicated to the transaction processing server. If the transaction does not qualify according to the rules, the transaction may proceed normally (no reward) at block 533.

At block 535 if the transaction qualifies as for an award, an award notification may be communicated to the user. The award qualification may be determined in a variety of ways. In some embodiments, the merchant may set select goods that may be purchased using awards. In other embodiments, all goods from a merchant may be available for purchase using an award and the conversion from points to dollars may be constant or may vary. The conversion from points to dollars may be set by the merchants in advance or the conversion may change dynamically and may change on the basis of the user.

In execution, the reward sever 153 may compare activity data 115 to a threshold and if the activity data 115 is over the threshold, the transaction may occur where activity data 115 may be deducted from the user account and a value may be transferred to the merchant. If the activity data 115 is not over the threshold, the transaction may be denied and the user may be informed of the lack of activity data 115 or that another problem was encountered.

As mentioned previously, certain users may be more desirable to certain merchants than other users. Thus, a different threshold may be set for each user. In some embodiments, the merchant may adjust the threshold using a user interface. In other embodiments, the merchant may communicate a file which may contain the thresholds for various users. In another embodiment, an algorithm may be used to set the threshold. Further the algorithm may be a learning algorithm or artificial intelligence algorithm which may be tuned to set the threshold automatically for each user.

In a further aspect, the threshold may vary per item along with varying per user. For example, an item may be in high demand. Thus the merchant may raise the threshold for the item to be higher than for other items. Similarly, an item in which there is excessive stock may have the threshold lower. The adjustment may be by the merchant through a user interface, through the communication of a file or by an algorithm which may be a learning algorithm.

At block 540 in response to the user selecting to use the award, the award may be used to complete the transaction for the user. Systems like the payment network system 108 may exist to pay for goods and services using points or awards. At a high level, the good or service selected may have a price in points or dollars. Assuming the user has sufficient points, the system may translate the points into a form of commerce that may be communicated to the seller. The arrangement with the seller may be arranged previously. Similarly, the necessary points may be deducted from the account of the user.

At block 545, a remaining award balance for the user may be determined. By deducting the points used from the beginning balance an ending balance may be determined. In some embodiments, the remaining award balance may be communicated to the user.

At block, 550 the award usage may be communicated to the user. The user may then be confident the reward system has worked as intended. In addition, as previously noted, in some embodiments, the remaining award balance may be communicated to the user.

The communication may take on a variety of forms. If the activity sensor is a wearable activity sensor, the communication may appear on the wearable device to provide notice and positive feedback to the user that the activity resulted in a good or service. In other embodiments, the user may select the manner of communication such as a text message, an sms message, an email, a notification on an app, etc.

In addition, in some embodiments, the user may be able to select the device to which the communication may be communicated. For example, if rewards were earned using less electricity as tracked by a smart meter, it may not make sense to communicate a notice to the smart meter as many people rarely look at their smart meter. However, an email to a mobile computing device like a phone may be more meaningful and may be seen more readily by the user.

In an example, a user may work for Acme company A. Acme company may its workers to be more fit which may have advantages for Acme company. Acme may set up a system where users may be given activity tracking device 702s. The users may enroll in the activity tracking system such that cumulative data for each user may be stored and analyzed. With the user's permission, the enrollment data 119 from the activity tracking system may be communicated to an activity reward system. The activity of the user may be translated into points according to an algorithm and the points may be used to purchase goods or services. The user may select to use the activity points on a variety of goods or services which may be available for selection by the user. The required points may be deducted from the user's account, the points may be translated into a value which may be communicated to the merchant and the new points balance may be communicated to the user.

In another example, a government may decide using less electricity is a worthy goal. By monitoring electricity usage (an activity), award may be assigned. As the user buys things, the system may alert the user that awards earned by using less electricity may be available to be used to buy goods or services. In addition, the system may offer bigger rewards for saving electricity during peak usage times than during low usage times or may offer bigger rewards to users in a certain stressed sector than users in a less stressed sector.

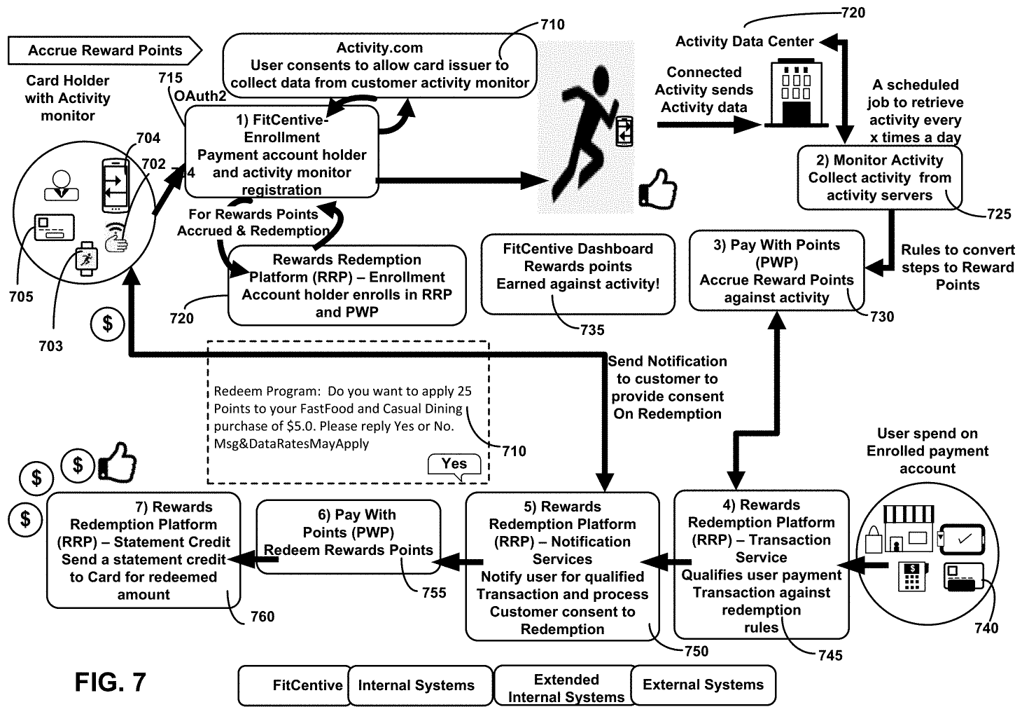

Referring to FIG. 7, another embodiment of the system pieces and method may be displayed. The system may be involve a user that has a wearable device like an activity tracker 702 or a smart watch 703 with an activity tracker function. The user may also have payment or credit accounts which may be represented by an electronic wallet 704 or a traditional credit card 705.

At block 710, a user may enroll in an activity tracking application. The enrollment may be an identification and a password. The identification may be a login, a fingerprint, a facial recognition, or a combination of all three. The password also may be a string of number or characters, a fingerprint or a facial image or a combination thereof.

At block 715 a user may enroll in an activity reward program. The enrollment may take the login data and password data from the activity tracking app 710 and, with sufficient permission, communicate the data to a rewards redemption platform 720. The user may then be enrolled in both the activity system and the rewards system and the user may begin to earn rewards which may be in the form of dollars, currency, points, tickets, goods or other useful forms of value.

At block 720, the use may communicate activity data 115 to the reward data server 153 and the activity data 115 may be stored and analyzed. The activity data 115 may be communicated in real time, periodically or whenever the user connects the activity tracking device 702 to a node which communicates the activity data 115 to the activity data 115 center. In addition, the user may register payment devices as part of a payment with points (PWP) system 157 such that when payments are made with the registered payment devices, the system may determine if rewards may be used.

At block 725, the activity of the user may be monitored and analyzed. In one aspect, the activity data 115 may be communicated to a variety of servers and the activity data 115 may need to be accumulated in a central location. Once the data is accumulated, it may be analyzed to determine how to translate the activity data 115 into a form of value like points. In some embodiments, an algorithm may be used to make the translation. In additional embodiments, the algorithm may be a learning algorithm and artificial intelligence may be used to assist in making the transition.

At block 730, the Pay With Points server 157 may accumulate the awards that were determined at block 725. In some embodiments, awards may be earned from a variety of different systems and the awards may be accumulated at block 730.

At block 735, the determine determined award points may be communicated to the user. In some embodiments, the awards may be displayed in a dashboard that is accessible to the user. In other embodiments, the awards may be communicated periodically to the user. In some embodiments, the rewards may be communicated to the activity earning device to further enforce the positive impact of the desired behavior. For example, if a fitness tracker is used, the rewards earned may be communicated to the fitness tracker.

At block 740, the use may make a purchase using a payment device that has been registered with the reward redemption program 157 at block 720. The payment device may be a credit card, an electronic wallet, a brokerage account, a debit card or any other payment device that represents a store of value or an amount of available credit.

At block 745, a reward redemption platform (RRP) 157 may apply rules to determine if a transaction qualifies to use award points. As mentioned previously, the reward redemption platform 157 may use an algorithm or may use artificial intelligence or machine learning to determine the rate at which awards may be converted to goods or services. Further, the type of goods and services may matter. For example, goods that are in high demand may not qualify at all for an award purchase. In other embodiments, goods that are in high demand may require an extensive amount of points. Similarly, good that are overstocked may be subject to a lower threshold.

At block 750, the rewards redemption platform (RRP) 159 may activate a notification service that the proposed transaction from block 740 met the rules at block 745 and is available to be completed used rewards. The RRP system may notify the user of the qualifies transaction. In some embodiments, the notification may be communicated to the activity tracking device 702, the smart phone with activity tracking 704, smart watch 703 or other portable computing device associated with the user. The user may be provided with options on how to respond to the message. In some embodiments, the user may set up a default response such as “accept all offers” or “accept all offers under 200 points” or “accept all offers under $50.” In other embodiments, the user may be prompted for a response before the Pay With Points system 157 may set up payment.

At block 755, if the response for the user was “yes, use the award points” which may be set as a default or may be communicated by the user, the Pay With Points system 157 may arrange for the payment.

At block 760, the reward redemption platform (RRP) 157 may arrange to settle the necessary debits and credits from the transaction. In one embodiment, the RRP may issue a statement credit to the payment device used for the redeemed amount. In other embodiments, the RRP system may issue the credit directly to the merchant to pay for the good or the service.

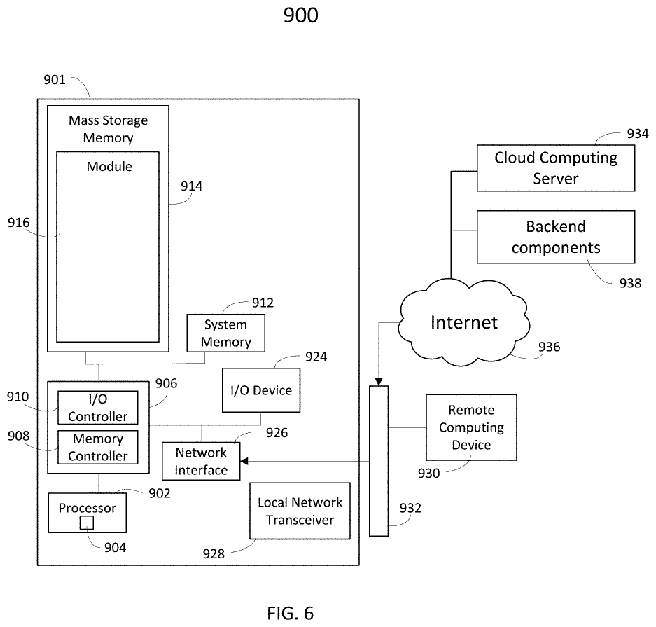

As shown in FIG. 6, the computing device 901 includes a processor 902 that is coupled to an interconnection bus. The processor 902 includes a register set or register space 904, which is depicted in FIG. 6 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 6, the computing device 901 may be a multi-processor device and, thus, may include one or more additional processors that are identical or similar to the processor 902 and that are communicatively coupled to the interconnection bus.

The processor 902 of FIG. 6 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 6 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 6 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method to earn rewards for exercise comprising
at a reward server, enrolling a payment device for a user in a reward program (from Fitbit, from purchase)
at an activity collection server,
tracking activity data from the user;
communicating activity data for the user to a reward server;
at the reward server,
determining appropriate rewards to be granted to the user based on the activity data for the user;
awarding the appropriate awards for the user to an award account for the user;
at a transaction processing server,
determining if a transaction for the user qualifies for an award according to redemption rules;
if the transaction qualifies as for an award, communication an award notification to the user;
in response to the user selecting to use the award, using the award to complete the transaction for the user;
determining an remaining award balance for the user; and
communicating the award usage to the user.

2. The method of claim 1, wherein activity data is from an Internet of Things (IoT) device.

3. The method of claim 2, wherein the IoT device comprises a smart meter on a device.

4. The method of claim 2, wherein IoT device comprises a smart car.

5. The method of claim 2, wherein IoT device is tracked to encourage or deter behavior.

6. The method of claim 1, wherein enrollment in the reward program comprising allowing the activity collection server to communicate enrollment data to the reward server.

7. The method of claim 1, wherein the payment device comprises a code that represents a store of value or amount of credit available for making purchases.

8. The method of claim 1, wherein activity data is collected from a wearable sensor.

9. The method of claim 8, wherein the activity collection server has permission to collect data from the activity server.

10. The method of claim 1, wherein the reward sever compares activity data to a threshold.

11. The method of claim 10, wherein the threshold varies per user.

12. The method of claim 10, wherein the threshold varies per product.

13. The method of claim 10, wherein merchants adjust the threshold using a user interface.

14. The method of claim 1, wherein award usage is communicated to the wearable device.

15. The method of claim 1, wherein the activity server receives data from an activity sensor that is a wearable sensor that is used as part of the transaction process.

16. The method of claim 1, wherein the activity data is used by merchants to adjust threshold.

17. The method of claim 1, wherein the activity data is accessed using an api.

18. The method of claim 1, wherein enrollment comprises using an api allow enrollment using data from other applications.

19. The method of claim 1, wherein an activity tracker id is attached to account using tokens.

20. The method of claim 1, wherein the activity data is communicated using an API.
